(19) United States
(12) Patent Application Publication
(10) Pub. No.: US 2011/0132546 A1
(43) Pub. Date: Jun. 9, 2011

(54) Apparatus for manufacturing printed circuit board

(75) Inventors: Yoong Oh, Jinhae-si (KR); Dek Gin Yang, Cheongwon-gun (KR)

(73) Assignee: Samsung Electro-Mechanics Co., Ltd., Suwon-si (KR)

(21) Appl. No.: 12/659,029

(22) Filed: Feb. 23, 2010

(30) Foreign Application Priority Data
Dec. 8, 2009 (KR) 10-2009-0121401

(51) Int. Cl. B32B 38/14; B32B 37/02; B32B 38/04

(52) U.S. Cl. 156/378; 156/390

(57) ABSTRACT

Disclosed is an apparatus for manufacturing a printed circuit board. The apparatus for manufacturing the printed circuit board includes: a supplier for supplying a substrate of a sheet type; a first printer for printing paste on the substrate supplied from the supplier to thereby form preliminary bumps; a provisional dryer which is arranged on one side of the first printer and provisional-dries the preliminary bumps; a second printer which is arranged on one side of the provisional dryer to be in series to the first printer and prints paste on the preliminary bumps; a dryer which is arranged on one side of the second printer and dries and cures the preliminary bumps to thereby form bumps; and a penetrator which is arranged on one side of the dryer, and allows the bump to pass through prepreg and bonds the prepreg and the substrate together.

### CROSS-REFERENCE TO RELATED APPLICATIONS

This application claims the benefit of Korean Patent Application No. 10-2009-0121401 filed with the Korea Intellectual Property Office on Dec. 8, 2009, the disclosure of which is incorporated herein by reference.

### BACKGROUND OF THE INVENTION

1. Field of the Invention

The present invention relates to an apparatus for manufacturing a printed circuit board; and, more particularly, to an apparatus for manufacturing a printed circuit board which serially arranges printers capable of printing and forming bumps.

2. Description of the Related Art

In general, a multi-layer printed circuit board is manufactured by forming an inner-layer circuit, and then sequentially layering an insulating layer and a circuit layer.

In this case, a Buried bumpinterconnection technology (B2it) has become commercially used as an inter-layer electrical conduction method of a multi-layer printed circuit board. This method is based on the fact that paste is printed on a substrate to thereby form paste bumps and inter-layer electrical conduction is achievable as the paste bumps passes through an insulating material. For this reason, it is easier and simpler to perform layering processes than other inter-layer electrical conduction method.

The apparatus for manufacturing a printed circuit board employing the B2it includes printers, dryers, and penetrators. Herein, the printers print paste to thereby form bumps, the dryers dry the printed bumps, and the penetrator allows the completely-formed bumps to pass through the insulating material.

Herein, since paste used for formation of bumps has a high viscosity index, the paste must be repeatedly subjected to print and dry processes several times until the paste is formed to have a predetermined height. To this end, in the apparatus for manufacturing a printed circuit board, each of printers arranged in parallel to one another prints paste on the substrate in such an iterative manner that the bumps become as high as desired heights.

In this case, this iterative manner performed by the printers brings out delay in process lead time. Thus, a great deal of raw material and energy is consumed due to the delay, which causes rise in cost price. In addition, the parallel arrangement of the printers requires increased movement distances from workers. Accordingly, workers have trouble managing processes.

Therefore, there is a need for the development of an apparatus for manufacturing a printed circuit board for B2it in which it is possible to reduce lead time and manage processes with ease.

### SUMMARY OF THE INVENTION

The present invention has been proposed in order to overcome the above-described problems and it is, therefore, an object of the present invention to provide an apparatus for manufacturing a printed circuit board for serially arranging printers which prints paste to thereby form bumps.

In accordance with one aspect of the present invention to achieve the object, there is provided an apparatus for manufacturing a printed circuit board including: a supplier for supplying a substrate of a sheet type; a first printer for printing paste on the substrate supplied from the supplier to thereby form preliminary bumps; a provisional dryer which is arranged on one side of the first printer and provisional-dries the preliminary bumps; a second printer which is arranged on one side of the provisional dryer to be in series to the first printer and prints paste on the preliminary bumps; a dryer which is arranged on one side of the second printer and dries and cures the preliminary bumps to thereby form bumps; and a penetrator which is arranged on one side of the dryer, and allows the bump to pass through prepreg and bonds the prepreg and the substrate together.

The first and second printers includes a first squeeze for performing printing in a first direction, and a second squeeze for performing printing in a second direction opposite to the first direction.

The dryer includes a first dryer for allowing solvent of the preliminary bumps to be volatilized, and a second dryer for completely curing the preliminary bumps.

The prepreg is of a roll type and is provided to the penetrator.

The apparatus further includes a cutter which is arranged on one side of the penetrator and cuts the prepreg of the substrate provided from the penetrator per cutting unit.

The prepreg is of a sheet type and is provided to the penetrator.

The apparatus further includes a penetrating tester which is arranged on one side of the cutter and examines a state of bump's penetration.

The apparatus further includes a bump height tester which is arranged between the second printer and the dryer.

### BRIEF DESCRIPTION OF THE DRAWINGS

These and/or other aspects and advantages of the present general, inventive concept will become apparent and more readily appreciated from the following description of the embodiments, taken in conjunction with the accompanying drawings of which:

FIG. 1 is a schematic view showing an apparatus for manufacturing a printed circuit board in accordance with a first embodiment of the present invention;

FIG. 2 is a schematic view showing printers of FIG. 1;

FIG. 3 is a schematic view showing a penetrator of FIG. 1;

FIG. 4 is a schematic view showing an apparatus for manufacturing a printed circuit board in accordance with a second embodiment of the present invention; and

FIG. 5 is a view schematically showing the penetrator of FIG. 4.

### DETAILED DESCRIPTION OF THE PREFERABLE EMBODIMENTS

Embodiments of an apparatus for manufacturing a printed circuit board in accordance with the present invention will be described in detail with reference to the accompanying drawings. When describing them with reference to the drawings, the same or corresponding component is represented by the same reference numeral and repeated description thereof will be omitted.

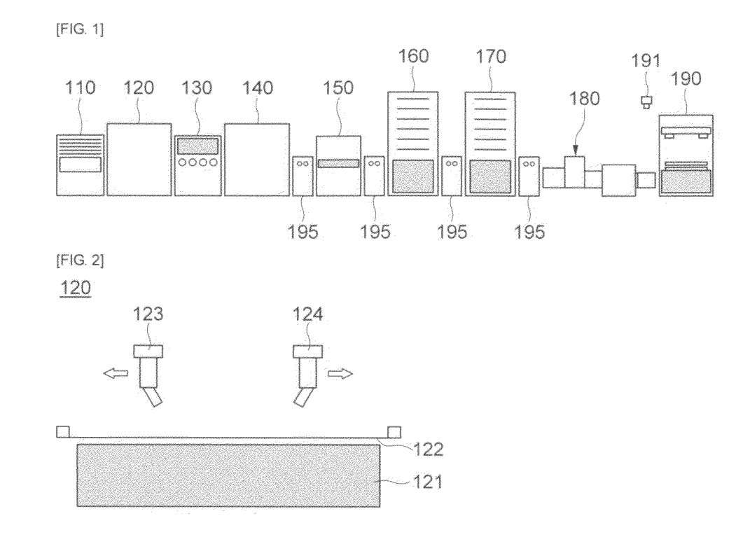

A description will be given of an apparatus for manufacturing a printed circuit board in accordance with an embodiment of the present invention, with reference to FIGS. 1 to 3.

FIG. 1 is a schematic view of an apparatus for manufacturing a printed circuit board in accordance with a first embodiment of the present invention.

FIG. 2 is a schematic view of a printer shown in FIG. 1.

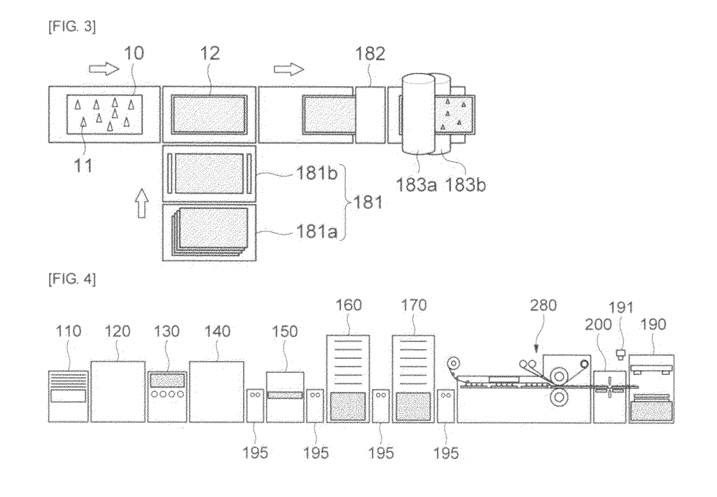

FIG. 3 is a schematic view of a penetrator shown in FIG. 1.

Referring to FIG. 1, the apparatus for manufacturing a printed circuit board includes a supplier 110, a first printer 120, a provisional dryer 130, a second printer 140, dryers 160 and 170, and a penetrator 180.

The supplier 110 supplies a substrate to the first printer 120. Herein, the substrate may be a copper plate or a substrate with printed circuits. In this case, the substrate may be of a sheet type. Thus, the substrate of a sheep type requires no constant tension differently from a substrate of a roll type, so that it is possible to easily perform printing.

The first printer 120 and the second printer 140 print conductive paste on the substrate supplied from the supplier 110 to thereby form preliminary bumps. In this case, the second printer 140 plays a role of increasing a height of the preliminary bumps through printing of the conductive paste on the printed preliminary bumps.

In order to increase the heights of the preliminary bumps by using the conventional printer which performs printing only in a single direction, it is necessary to arrange printers in parallel to one another and form preliminary bumps in an iterative manner. As a result, it spends a lot of lead time during printing processes.

However, each of the first printer 120 and the second printer 140 in accordance with an embodiment of the present invention can print conductive paste in both directions.

A detailed description will be given of the first printer 120 and the second printer 140, with reference to FIG. 2. Herein, the first and second printers 120 and 140 may have the same structure as each other. FIG. 2 shows the first printer 120 alone, for the convenience of explanation.

Each of the first and second printers 120 and 140 may include a table 121, a mask 122, and first and second squeezes 123 and 124. Herein, the table 121 fastens the substrate in order to stably perform printing.

The mask 122 is provided with openings corresponding to areas where the bumps are formed. In this case, the mask 122 is arranged on the substrate, and the mask 122 is used to form the bumps on the areas where the bumps are to be formed. The squeeze 123 comes into contact with the mask 122, and prints conductive paste while moving in a first direction, whereas the squeeze 124 comes into contact with the mask 122 and prints conductive paste in a second direction opposite to the first direction. Thus, each of the first printer 120 and the second printer 140 can print the conductive paste in both directions, so that two-time printing can be made per one printer. Therefore, through the first printer 120 and the second printer 140, it is possible to reduce lead time during printing processes.

Also, as shown in FIG. 1, the substrate sequentially undergoes the first printer 120 and the second printer 140 to thereby form preliminary bumps enough to meet a design value on the substrate, so that it is possible to arrange the first printer 120 and the second printer 140 in series. Therefore, substrates sequentially supplied to each of the first printer 120 and the second printer 140 require no standby time, so that it is possible to reduce lead time during printing processes.

Furthermore, since the first printer 120 and the second printer 140 are arranged in series, the movement distances of workers are reduced and thus management of processes is easier.

The provisional dryer 130 is arranged on one side of the first printer 120, that is, between the first printer 120 and the second printer 140, and provisional-dries the preliminary bumps printed by the first printer 120 so as to maintain the shape of the preliminary bumps.

The dryers 160 and 170 are arranged on one side of the second printer 140. Herein, the dryers 160 and 170 perform curing and drying of the preliminary bumps formed to have a predetermined height by the second printer 140 to thereby form bumps. In this case, the dryers 160 and 170 may include a first dryer 160 and a second dryer 170, wherein the first dryer 160 allows organic solvent remaining in the preliminary bumps to be volatilized and the second dryer 170 allows the preliminary bumps to be completely cured.

The penetrator 180 allows the bumps formed on the substrate to pass through a prepreg, and the substrate and the pregreg are bonded together. Herein, the prepreg may be of a sheet type. In this case, the penetrator 180 may be provided with a prepreg supplier 181.

A detailed description will be given of the penetrator 180 with reference to FIG. 3. The penetrator 180 may include a prepreg supplier 181, a pre-heater 182, and first and second rollers 183a and 183b.

The prepreg supplier 181 may include a stack booth 181a in which the prepregs are layered in a sheet type, and a centering booth 181b which arranges positions of the sheets outputted from the stack booth 181a. In this case, the prepreg supplier 181 may supply the prepreg 12 on the substrate 10 having the bump 11 formed thereon through movement of the stack booth 181a and the centering booth 181b.

The pre-heater 182 pre-heats the substrate 10 including the prepreg 12. Thus, a cured degree of the prepreg becomes reduced and the prepreg 12 is penetrated by the bump 11 with ease.

The first and second rollers 183a and 183b rotate while engaging with each other. In this case, as the substrate 10 with the bumps 11 and the prepreg 12 pass between the first and second rollers 183a and 183b, the first and second rollers 183a and 183b apply pressure to the prepreg 12 in such a manner that the bumps 11 pass through the prepreg 12, so that the prepreg 12 and the substrate 10 can be made bonded together. Thus, it is possible to manufacture the substrate 10 in which inter-layer electrical conduction is achievable. The substrate manufactured in this manner is received into the receiver 190 arranged on one side of the penetrator 180.

Additionally, as shown in FIG. 1, the substrate may be moved to respective process devices (i.e., first and second printers 120 and 140, dryers 160 and 170, and penetrator 180) through the conveyer 195.

Also, a bump height tester 150 may be further arranged on one side of the second printer 140. The bump height tester 150 measures the heights of the preliminary bumps supplied from the second printer 140, thereby identifying whether or not the preliminary bump is formed to have a height corresponding to a design value.

Also, a penetrating tester 191 may be further arranged on one side of the penetrator 180, that is, between the penetrator 180 and the receiver 190, so as to examine a penetration state. The penetrating tester 191 irradiates light on the top of the completely formed substrate and acquires the bump's shadow generated by the light so as to determine failure or non-failure of the bumps through the use of the shadow image, thereby providing failure-information to workers. Thus, the workers can continue to monitor failure or non-failure of the penetrator 180.

Therefore, in the embodiment of the present invention, printers capable of bi-directional printing are arranged in series to one another, so that it is possible to reduce cost price and process lead time, and to easily manage the processes.

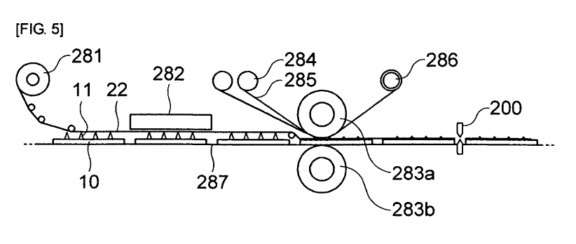

Hereinafter, a description will be given of an apparatus for manufacturing a printed circuit board in accordance with a second embodiment of the present invention, with reference to FIGS. 4 and 5. Herein, the apparatus for manufacturing the printed circuit board in accordance with a second embodiment of the present invention has the same constructions as those of the printed circuit board in accordance with the first embodiment of the present invention, except for the penetrator and the cutter. Thus, the repeated description thereof will be omitted, and those components that are the same or are in correspondence are rendered the same reference numeral.

FIG. 4 is a schematic view showing a printed circuit board in accordance with a second embodiment of the present invention.

FIG. 5 is a view schematically showing the penetrator of FIG. 4.

Referring to FIGS. 4 and 5, the apparatus for manufacturing a printed circuit board according to the embodiments of the present invention includes a supplier 281, first an second printers 120 and 140, a provisional dryer 130, and dryers 160 and 170, and a penetrator 280. Herein, the supplier 281 supplies a substrate 10, and the first and second printers 120 and 140 are arranged in series to one another and print paste on the substrate 10 supplied from the supplier 281 to form preliminary bumps. The provisional dryer 130 is arranged between the first and second printers 120 and 140, and dryers 160 and 170 are arranged on one side of the second printer 140 and perform drying and curing of the preliminary bumps to thereby form bumps. The penetrator 280 allows the bump 11 to pass through the prepreg 22 to thereby bond the prepreg 22 and the substrate 10 together.

Herein, the prepreg 22, which is of a roll type, may be provided to the penetrator 280. In this case, the penetrator 280 may include a prepreg roll 281, a pre-heater 282, first and second rollers 283a and 283b, and a protection roller unit.

The prepreg roll 281 whose roller is surrounded by the prepreg 22. The prepreg roll 281 supplies the prepreg 22 on the substrate 10 having the bumps 11 formed thereon by rotation of the roller.

The pre-heater 282 pre-heats the substrate 10 including the prepreg 22. Thus, it is possible to easily perform a penetration process at the time of bonding the prepreg 22 and the substrate 10 together.

The first and second rollers 283a and 283b rotates while engaging with each other, so that the prepreg 22 is penetrated by the bumps 11 to be bonded to the substrate 10. In this case, the bump having penetrated the prepreg 22 comes into direct contact to the first and second rollers 283a and 283b, and thus makes the bumps 11 defective.

In order to prevent this problem, the protection roller unit is further provided.

Herein, the protection roller unit may include a protection roller 284 which is rolled by the protection film 285 and supplies the protection film 285 on the substrate including the prepreg 22 between the first and second rollers 283a and 283b. The protection roller unit may further include a recovery roller 286 for recovering a protection film 285 passing between first and second rollers 283a and 283b. Herein, during the penetration process, the first and second rollers 283 and 283b applies pressure directly to the bumps 11 as the protection film 285 is arranged on the prepreg 22 including the bumps 11, so that it is possible to prevent damage of the bumps 11. In this case, although the protection roller 284 is shown to be two in number in the drawings, the present invention is not limited thereto. The number of the protection rollers may be provided to be at least one according to the height and strength of the protected bumps. In this case, the protection film 285 may be made of a material with elasticity enough to protect the damage of the bumps 11 due to the pressure of the first and second rollers 283a and 283b.

Furthermore, the protection film 285 may have releasing property to enable the bumps 11 or the pregreg 22 to be separated easily apart from the first and second rollers 283a and 283b.

For example, the protection film 285 may include teflon-based resin or silicon-based resin.

In addition, the penetrator 280 may further include a transfer belt 287 for transferring the substrate 10 during the penetration process.

Since the prepreg 22 is of a roll type, the apparatus for manufacturing the printed circuit board may further include a cutter 200 for cutting the prepreg by cutting unit. In this case, the cutter 200 is arranged on one side of the penetrator 280, and cuts the prepreg 22 per cutting unit, that is, cuts the prepreg 22 in such a manner to correspond to the substrate 10, wherein the prepreg 22 has passed through the bumps 11 and has bonded to the substrate 10.

Therefore, in an apparatus for manufacturing a printed circuit board according to the embodiments of the present invention, the penetrator uses the roll-type prepreg, so that it is possible to arrange corresponding devices (e.g. equipment) in series to one another. Therefore, it is possible to reduce movement distances of workers, and thus to facilitate management of the processes and to reduce lead time of processes as well.

In the apparatus for manufacturing a printed circuit board in accordance with embodiments of the present invention, printers capable of printing and forming bumps are arranged in series to one another, so that it is possible to reduce lead time required for processes and thus to reduce cost price and movement distances of workers, which results in effective management of processes.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. An apparatus for manufacturing a printed circuit board comprising:
a supplier for supplying a substrate of a sheet type;
a first printer for printing paste on the substrate supplied from the supplier to thereby form preliminary bumps;
a provisional dryer which is arranged on one side of the first printer and provisional-dries the preliminary bumps;
a second printer which is arranged on one side of the provisional dryer to be in series to the first printer and prints paste on the preliminary bumps;
a dryer which is arranged on one side of the second printer and dries and cures the preliminary bumps to thereby form bumps; and
a penetrator which is arranged on one side of the dryer, allows the bump to pass through prepreg to bond the prepreg and the substrate together.

2. The apparatus of claim 1, wherein the first and second printers include a first squeeze for performing printing in a first direction, and a second squeeze for performing printing in a second direction opposite to the first direction.

3. The apparatus of claim 1, wherein the dryer includes a first dryer for allowing solvent of the preliminary bumps to be volatilized, and a second dryer for completely curing the preliminary bumps.

4. The apparatus of claim 1, wherein the prepreg is of a roll type and is provided to the penetrator.

5. The apparatus of claim 4, further comprising a cutter which is arranged on one side of the penetrator and cuts the prepreg of the substrate provided from the penetrator per cutting unit.

6. The apparatus of claim 1, wherein the prepreg is of a sheet type and is provided to the penetrator.

7. The apparatus of claim 1, further comprising a penetrating tester which is arranged on one side of the cutter and examines a state of bump's penetration.

8. The apparatus of claim 1, further comprising a bump height tester which is arranged between the second printer and the dryer.
